(19) United States
(12) Patent Application Publication
(10) Pub. No.: US 2009/0057280 A1
(43) Pub. Date: Mar. 5, 2009

(54) Method for Embellishing Surface of Handle via Laser Engraving Machine

(76) Inventor: Leo Jaw, Ta Tu Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/845,408

(22) Filed: Aug. 27, 2007

(51) Int. Cl. B23K 26/38

(52) U.S. Cl. 219/121.69

(57) ABSTRACT

A method for embellishing surface of a handle includes: first step: preparing a body of the handle injected from a mold; second step: laser-engraving the body of the handle to form a plurality attached portions thereon; third step: preparing a skin with pattern or color and laser-cutting the skin to form a plurality of ornamental skins corresponding to the attached portions; fourth step: attaching the ornamental skins to the corresponding attached portions on the body and getting a finished handle.

### BACKGROUND OF THE INVENTION

1. Field of the Invention

The present invention relates to a method for embellishing surface of a handle and, more particularly, to a method for embellishing surface of a handle by using a laser engraving machine.

2. Description of the Prior Art

FIGS. 8 to 10 show a conventional method for embellishing surface of a handle 1 that includes the following steps: first step is forming a body 2 via injection molding from a mold and simultaneously a plurality of attached portions 3 formed on the surface of the body 2, second step is the body 2 injecting from the mold, third step is attaching a plurality of ornamental skins 4 to the corresponding attached portions 3 on the body 2.

Due to the shrink of the body 2 of the handle 1 injecting from the mold, the mold for the body 2 should be made with great precision so that the attached portions 3 having accurate size would be formed. Therefore, it would increase cost for making the mold.

Moreover, suppose that size of the attached portions 3 do not match with that of the ornamental skins 4 and it causes an imperfect attachment of the ornamental skins 4 and the attached portions 3 and raise the defective rate of embellishing the handle.

Thus, to make different shapes of the ornamental skins should make different molds for corresponding to the said ornamental skins. However, the high cost of making molds would influence customers who just demand low-volume production.

The present invention has arisen to mitigate and/or obviate the afore-described disadvantages.

### SUMMARY OF THE INVENTION

The present invention solves this need and other problem in the field of methods for embellishing surface of handle by providing, a method for embellishing surface of handle via laser engraving including the following steps: first step is injecting a body of a handle from a mold; second step is laser-engraving the body to form a plurality desired-shaped attached portions thereon; third step is preparing a skin with pattern or color and laser-cutting the skin to form a plurality of desired-shaped ornamental skins; fourth step is attaching the desired-shaped ornamental skins to the corresponding attached portions and getting a finished handle.

The present invention will become clearer in light of the following detailed description of illustrative embodiment of this invention described in connection with the drawings.

### BRIEF DESCRIPTION OF THE DRAWINGS

FIG. 1 is a flow chart showing a method for embellishing surface of a handle in accordance with the present invention.

FIG. 2 shows a perspective view of a body of the handle injected from a mold in accordance with the present invention.

FIG. 3 shows a perspective view of the body of the handle in accordance with the present invention, embellished surface thereof by using a laser engraving machine.

FIG. 4 shows a perspective view of embellished surface of the body of the handle in accordance with the present invention.

FIG. 5 shows a perspective view of a skin in accordance with the present invention, cut for a plurality of desired ornamental skins by using a laser engraving machine.

FIG. 6 shows a perspective view of the body of the handle in accordance with the present invention, attached with the ornamental skins thereon in accordance with the present invention.

FIG. 7 shows a perspective view of a finished handle in accordance with the present invention.

FIG. 8 shows a perspective view of a mold for a conventional handle with a plurality of attached portions.

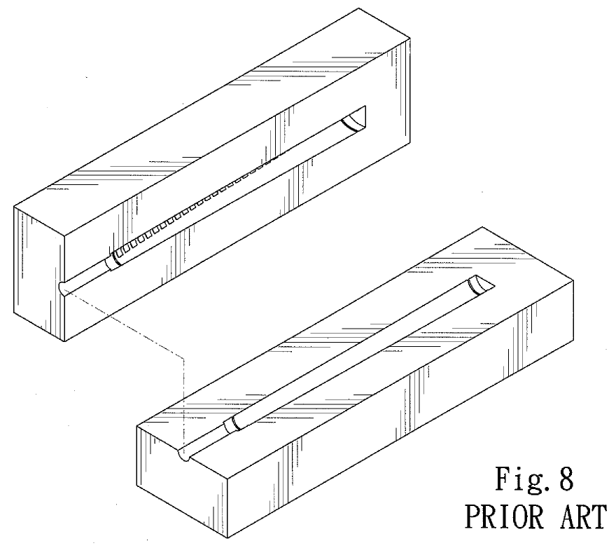

FIG. 9 shows a perspective view of the conventional handle formed via said mold.

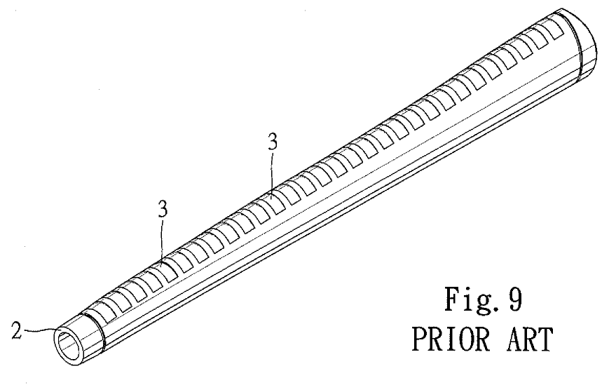

FIG. 10 shows a perspective view of the conventional handle attached with a plurality of ornamental skins corresponding to the attached portions of the conventional handle.

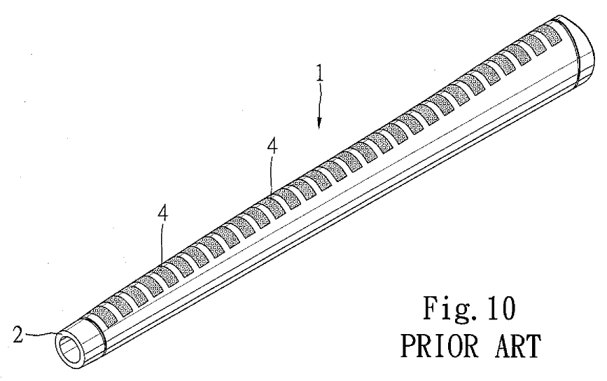

### DETAILED DESCRIPTION OF THE PREFERRED EMBODIMENT

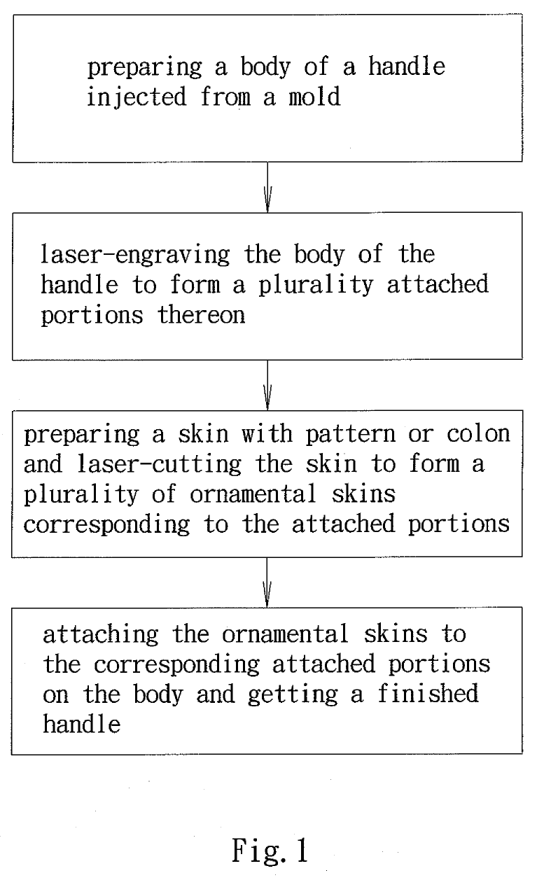

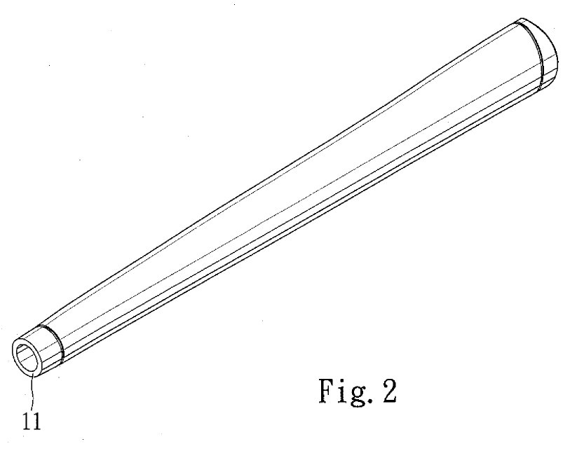

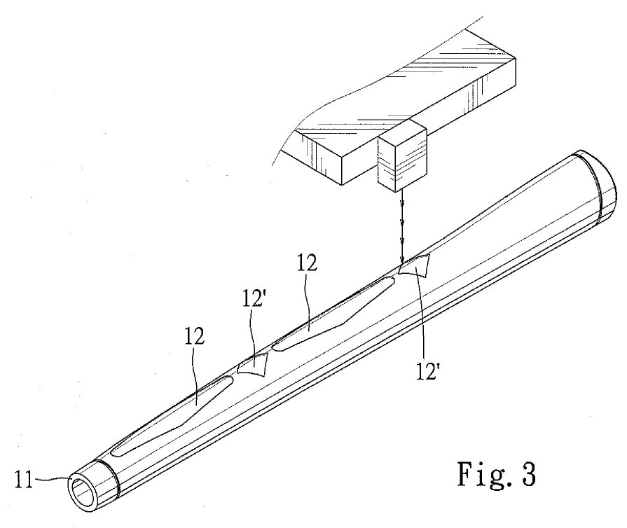

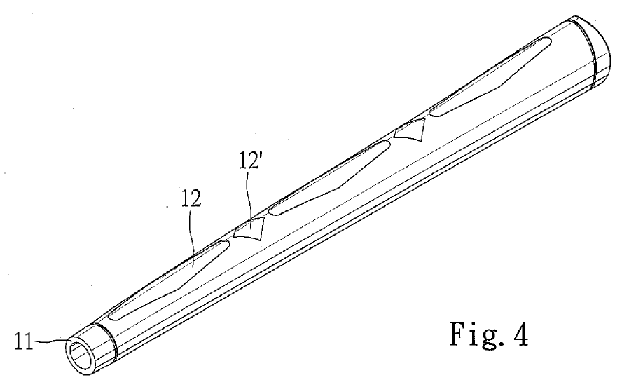

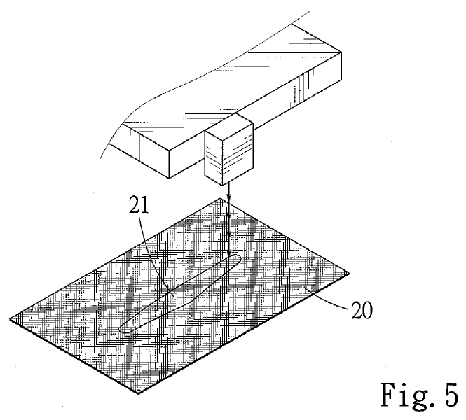

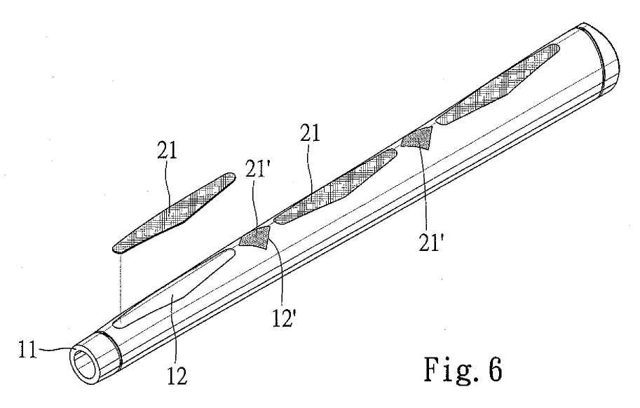

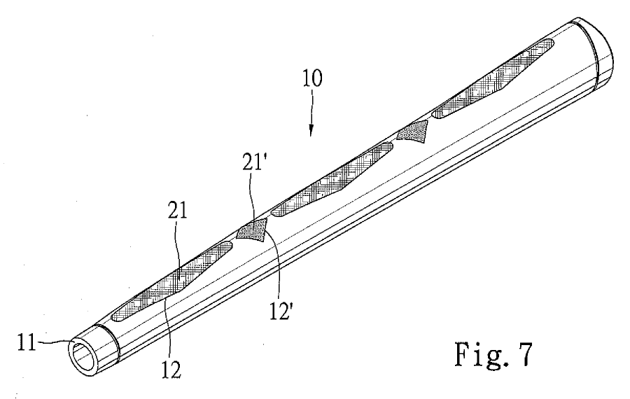

Referring to FIG. 1, a method for embellishing surface of a handle 10 according to the present invention includes the following steps: first step is injecting a body 11 from a mold (seen in FIG. 2); second step is preferably embellishing surface of the body 11 to form a plurality of desired-shaped attached portions 12, 12′ in the present invention, and the depth and size of the attached portions 12, 12′ are adjustable and controlled by a laser engraving machine (seen in FIGS. 3 and 4); third step is preparing a skin 20 with pattern or color and cutting the skin 20 for forming a plurality of desired-shaped ornamental skins 21, 21′ respectively corresponding to the attached portions 12, 12′ of the body 11 (seen in FIG. 5); fourth step is attaching the ornamental skins 21, 21′ to the attached portions 12, 12′ of the body 11 by agglutinant, hot-pressing or high-frequency heating and getting a finished handle 10 (seen in FIGS. 6 and 7).

The body 11 is provided for the attached portions 12, 12′ thereon with accurate size by laser engraving and it's unnecessary to concern that the shrink of the body 11 after injected from the mold. The depth and size of the attached portions 12, 12′ could be controlled by the laser engraving machine.

The ornamental skins 21, 21′ are formed by laser-cutting the skin 20 and the shape of the ornamental skins 21, 21′ are respectively corresponding to that of the attached portions 12, 12′ of the body 11. It could solve the problem of disagreement of the ornamental skins 21, 21′ and the attached portions 12, 12′ and reduce the defective rate of production.

The attached portions 12, 12′ of the body 11 and the ornamental skins 21, 21′ could be formed to various desired-shapes according to the different request of customers via laser engraving. And it's unnecessary to make various molds for forming different shaped attached portions of the handle. The method for embellishing the handle according to the present invention allows manufacturing the desired production that customers request for and reducing the cost of making the molds for the handle with various embellishments.

The present invention provides a kind of laser with high power-density for scanning surface of the handle 10 to heat the body 11 to thousand degrees even to ten thousand degrees, thus the material of the body 11 would fuse or vapor. Then, to blow the fused or vapored parts of the body 11 by high-pressured air and to form a plurality of desired-shaped attached portions 12 on the body 11. And the skin 20 could be cut for forming a plurality of desired-shaped ornamental skins by the same token. The present invention preferably uses CO2 laser machine or Nd-Yag Laser machine.

The method for embellishing on the handle via laser engraving according to the present invention would promote environmental protection and the method could replace the conventional printing or labels provided on the handle. Moreover, the laser-engraving embellishment would not come off from the handle.

The method for embellishing on the handle via laser engraving according to the present invention is humanized processed-technique and it could reduce the cost to make various molds corresponding to various embellishments on the handles. Formerly, the brand labels usually are printed or stuck on the surface of goods; therefore, if changing the brand label, it is necessary to make a new mold afresh. However, if using the method for embellishing the surface on the handle via laser engraving machine, while changing the brand label, the customers just need to change the pattern for laser engraving. In additional, embellishing the surface on the handle by laser engraving could make the impression of goods better.

Thus since the invention disclosed herein may be embodied in other specific forms with out departing from the spirit or general characteristics thereof; some of which forms have been indicated, the embodiments described herein are to be considered in all respects illustrative and not restrictive. The scope of the invention is to be indicated by the appended claims, rather than by the foregoing description, and all changes which come with the meaning and range of equivalency of the claims are intended to be embraced therein.

What is claimed is:

1. A method for embellishing surface of a handle comprising:
first step: preparing a body of the handle injected from a mold;
second step: laser-engraving the body of the handle to form a plurality attached portions thereon;
third step: preparing a skin with pattern or color and laser-cutting the skin to form a plurality of ornamental skins corresponding to the attached portions;
fourth step: attaching the ornamental skins to the corresponding attached portions on the body and getting a finished handle.

2. A method for embellishing surface of a handle as claimed in claim 1, with the attached portions having different shape to each other.

3. A method for embellishing surface of a handle as claimed in claim 1, with attaching the ornamental skins to the attached portions of the body by agglutinant, hot-pressing or high-frequency heating.
